(19) United States
(12) Patent Application Publication
(10) Pub. No.: US 2010/0213715 A1
(43) Pub. Date: Aug. 26, 2010

(54) ARRANGEMENT FOR GENERATING ELECTRIC ENERGY

(75) Inventors: Arne Moberg, Enskede (SE); Peter Kjaerboe, Stockholm (SE); Henrik Bage, Stockholm (SE); Frederic Telander, Bromma (SE)

Correspondence Address: RENNER OTTO BOISSELLE & SKLAR, LLP, 1621 EUCLID AVENUE, NINETEENTH FLOOR, CLEVELAND, OH, 44115, US

(73) Assignee: SOLTECH ENERGY SWEDEN AB, Tullinge (SE)

(21) Appl. No.: 12/673,010

(22) PCT Filed: Jul. 24, 2008
(86) PCT No.: PCT/SE2008/050891

§ 371 Date: Feb. 24, 2010

(30) Foreign Application Priority Data
Aug. 15, 2007 (SE) 0701860-9

(51) Int. Cl. H02K 7/18; F03G 6/00; F24J 2/04

(52) U.S. Cl. 290/52; 60/641.8

(57) ABSTRACT

The present invention relates to an arrangement for generating electric energy. The arrangement comprises a light absorbing device comprising a gaseous medium adapted to be circulated by means of natural circulation and heated by incident light radiation and an energy transforming device adapted to absorb heat energy from the gaseous medium and to transfer the absorbed heat energy to electric energy.

### THE BACKGROUND OF THE INVENTION AND PRIOR ART

The arrangement comprises a light absorbing device which comprises an outer at least partly transparent material layer, a space through which a gaseous medium is adapted to be circulated and heated by light radiation passing through the outer the material layer, a radiation absorbing material layer located in connection to said space, and an element adapted to divide the space in at least a first subspace comprising a first opening and a second subspace comprising a second opening, wherein the gaseous medium is adapted to flow along a path extending from the opening in the first subspace to the opening in the second subspace and that said path has an extension such that the gaseous medium only has possibility to be conducted from the first subspace to the second subspace via a passage located at a lower level in the space than the levels of the first opening and the second opening.

With light is meant here not only light visible for the eye but electromagnetic light in general, comprising ultraviolet light and infrared light.

WO 02/33331 shows a light absorbing device according to the above. When the radiation absorbing material layer of the light absorbing device is subjected to incident solar radiation, it obtains an increased temperature. The gaseous first medium, which preferably is air, provides a heating when it comes in contact with the warm radiation absorbing material layer in the space. When the air is heated in the space, the air in one of the subspaces obtains a higher temperature than the air in the other subspace. Thus, a thermal unbalance is obtained between the air in the two subspaces and a natural circulation of air is established through the light absorber. The natural circulation of air is automatically started when the temperature of the air in the light absorber exceeds the temperature of the air located outside the openings of the subspaces and ceases automatically when the air in the light absorber drops to the same or to a lower temperature than the air located outside the openings of the subspaces. The air located outside the openings of the subspaces may be air located inside a building.

Consequently, such a light absorbing device does not need any energy consuming fan for transporting the medium through the space. The operating expense for the light absorbing device will thus be substantially non-existent. Consequently, the light absorbing device uses a gaseous medium, which preferably is air. The light absorbing device does thus not need any conduits which usually are required for transporting a liquid medium. Consequently, the risk for leakage resulting in water damages is eliminated. The light absorbing device may be given a simple construction and be manufactured to a low cost.

### SUMMARY OF THE INVENTION

The object of the present invention is to provide an arrangement making it possible to generate electric energy from the heat energy in the warm gaseous medium obtained from a light absorbing device according to the above.

This object is achieved with the arrangement of the initially mentioned kind, which is characterised in that the arrangement comprises an energy transforming device adapted to absorb heat energy from the gaseous medium which is let out from the second opening of the light absorbing device and to transfer the absorbed heat energy to electric energy. By such an energy transforming device, the heat energy in the gaseous medium can be absorbed and transferred to electric energy. This can be performed directly or in several steps. The energy transforming device transfers suitably the heat energy in the gaseous medium first to mechanical energy whereupon the mechanical energy is transferred to electric energy. The electric energy may be generated in the form of direct current or alternating current.

According to a preferred embodiment of the present invention, the energy transforming device comprises a circuit with a circulating cooling medium and an evaporator where the cooling medium is adapted to be evaporated and be pressurized by means of the absorbed heat energy from the gaseous medium. When a substance is heated and evaporated in a closed space, an over-pressure is created. The heat energy in the air may thus be transferred to pressure energy in the evaporator. A substance is chosen as cooling medium which evaporates at a lower temperature than the lowest temperature obtained by the gaseous medium after it has been heated in the light absorbing device. If the gaseous medium after the heating in the light absorbing device has a temperature within a temperature range, which may be 60° C.-80° C., the cooling medium must thus be able to be evaporated at a lower temperature than 60° C. at the prevailing pressure in the evaporator. The energy transforming device may comprise a machine unit which is driven by the evaporated cooling medium and which transfers the pressure energy of the cooling medium to electric energy. By such a machine unit, electric energy may be extracted from the pressurized cooling medium. Preferably, the machine unit comprises a first machine component adapted to transfer the absorbed heat energy to mechanical energy and a second machine component adapted to transfer the mechanical energy to electric energy. Such a first machine component may be a turbine or a piston machine of a suitable kind. The second machine component may be a generator.

According to another preferred embodiment of the present invention, said circuit is closed and it comprises en condenser, located downstream of said machine unit with respect to the flow direction of the cooling medium in the circuit, in which condenser the cooling medium is adapted to condensate before it is again conducted back to the evaporator. In the most cases, it is suitable to use a closed circuit for the cooling medium. Thus, the cooling medium has to condensate before it again can be used in the evaporator, which suitably is performed in a condenser. The energy transforming device may comprise a conduit system with a heat carrying medium adapted to be conducted through the condenser for cooling the cooling medium such that it condensates in the condenser. Such a heat carrying medium may be water or a water solution.

According to a preferred embodiment of the present invention the arrangement comprises a conduit adapted to lead the gaseous medium from the light absorbing device to the evaporator. In this case, the warm gaseous medium from the light absorbing unit is used for directly heating the cooling medium in the evaporator. Alternatively, the arrangement may comprise a heat exchanger where the gaseous medium from the light absorbing device is adapted to deliver heat energy to a heat carrying liquid medium which thereafter is conducted, via a conduit, to the evaporator. In this case, the gaseous medium indirectly heats the cooling medium in the evaporator through the heat carrying medium.

According to another preferred embodiment of the present invention, the light absorbing device consists a first unit and that the energy transforming device consists a second unit located at a distance from the first unit and that the arrangement comprises a conduit adapted to lead the gaseous medium from the second opening of the light absorbing device to the energy transforming device. The energy transforming device may be arranged on a sunny roof or wall in a building while the energy transforming device may be given a more protected position in a suitable place inside the building. With a separate energy transforming device, supervision and control of the energy transforming device is facilitated at the same time as connection of energy transforming devices with varying dimensions and capacity to the light absorbing device enables.

According to another preferred embodiment of the present invention, the arrangement comprises a return conduit adapted to lead the gaseous medium back to the inlet opening of the light absorbing device after it has delivered heat energy in the evaporator or to the heat carrying medium in the heat exchanger of the energy transforming device. After the gaseous medium has delivered heat energy in the evaporator or in the heat exchanger, it stills inevitably a somewhat increased temperature. By such a recirculation, gaseous medium may, with an increased temperature in relation to the surrounding, be conducted into the light absorbing device. Thus, the gaseous medium may also obtain a higher temperature when it leaves the light absorbing device having the result that the cooling medium in the evaporator is heated more effectively. The heat energy in the gaseous medium may thus be used for generating electric energy in an effective manner.

According to another preferred embodiment of the present invention, the arrangement comprises an outlet conduit adapted to let out the gaseous medium to a space, where there is a need of heating, after it has delivered heat energy in the evaporator or in the heat exchanger. The gaseous medium has, after it has been cooled in the evaporator, during most circumstances, a higher temperature than the air in the space. If there is a need of heating in the space, the gaseous medium may thus be used for such a heating. If the gaseous medium is air, it may be let out directly and mixed with the air in the space. In other case, the heat may be delivered to the air in the space via a suitable heat exchanger. The arrangement may comprise a valve by which it is possible to control the gaseous medium to the return conduit or the outlet conduit after it has delivered heat energy to the energy transforming device. If there is a need of heating, the valve may be set in a position such that the gaseous medium is used for heating. If there is no need of heating, the valve may be set in a position only for electric generating. The arrangement may also comprise en inlet conduit for supply of new gaseous medium to the first opening and a valve by which it is possible to control the supply of gaseous medium to the first opening from the return conduit to the inlet conduit. If the gaseous medium or a part of it is used for heating purposes, it is also possible to supply new gaseous medium to the light absorbing device by means of such a valve.

According to another preferred embodiment of the present invention, the second opening comprises a larger cross section area than the first opening. Thus, the flow resistance through the light absorbing device is reduced. The circulation of the gaseous medium in the conduit to the energy transforming device is also favoured.

### BRIEF DESCRIPTION OF THE DRAWINGS

In the following, preferred embodiments of the invention are described as examples with reference to the attached drawings, in which:

FIG. 1 shows a light absorbing device,

FIG. 2 shows a cross section view through the plane A-A of the light absorbing device in FIG. 1,

FIG. 3 shows an arrangement for generating electric energy according to a first embodiment,

FIG. 4 shows an arrangement for generating electric energy according to a second embodiment and

FIG. 5 shows an arrangement for generating electric energy according to a third embodiment.

### DETAILED DESCRIPTION OF PREFERRED EMBODIMENTS OF THE INVENTION

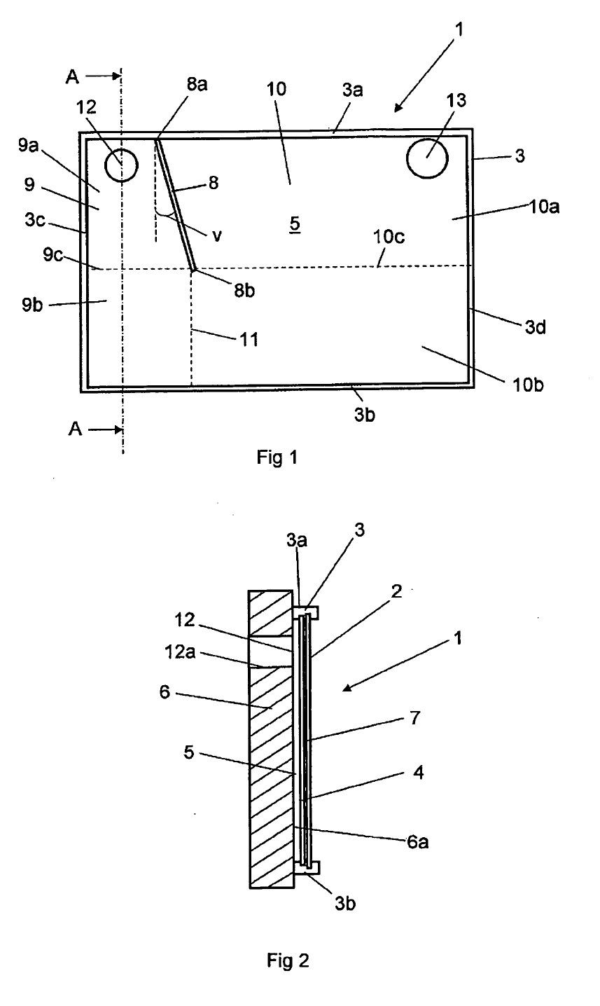

The FIGS. 1 and 2 show a light absorbing device which may be comprised in an arrangement for generating electric energy. The light absorbing device 1 comprises an outer material layer of a transparent material which is here exemplified as a plane glass plate 2. However, the outer material layer may consist of other materials such as suitable plastic materials. The outer material layer does not need to have a plane outer surface but it may have another shape and be consisted of roof tails manufactured of a transparent material. The glass plate 2 is attached in a frame construction 3 extending around the edges of the glass plate. The frame construction 3 here has a rectangular shape with an upper frame element 3a, a lower frame element 3b and two side frame elements 3c, 3d. Certainly, the frame construction 3 may have another shape.

The light absorbing device 1 comprises a radiation absorbing material layer which may be a plate 4 provided with a black surface. Certainly, other kinds of radiation absorbing material layers may be used such as flexible radiation absorbing material layers. A black radiation absorbing plate 4 has good radiation absorbing properties and it therefore obtains a high temperature when it is subjected to solar radiation. The radiation absorbing plate 4 is attached in the frame construction 3 in an internally position of the glass plate 2. In this case, the frame construction 3 is attached against a wall element 6 of a building. A space 5 is formed inside the radiation absorbing plate 4 adapted to be through flown by air. In this case, a surface of the wall element 6 forms a bottom surface 6a of the space 5. When air is conducted through the space 5, it comes in contact with an inner side of the radiation absorbing plate 4. An advantage of arranging the space 5 inside the radiation absorbing plate 4, it is that the air circulating in the space 5 does not come in contact with the glass plate 2. Thus, the inner surface of the glass plate 2 is prevented from being made dirty. A second space 7 is thus formed between the radiation absorbing plate 4 and the glass plate 2. The second space 7 forms a heat insulating layer between the glass plate 2 and the radiation absorbing plate 4. Preferably, the second space 7 contains air but it may also contain any other kind of gas or vacuum. Alternatively, it may contain a light transmitting fibre material having heat insulating properties.

An elongated element 8 is arranged in the space 5. The elongated element 8 is adapted to divide the space 5 in a first subspace 9 and a second subspace 10. The elongated element 8 has an extension between an upper end 8a abutting the upper frame element 3a and a lower end 8b located at a distance from the lower frame element 3b. The elongated element 8 is dimensioned such that it has a lower surface, which is in contact with the bottom surface 6a, and an upper surface, which is in contact with the radiation absorbing plate 4. Consequently, the elongated element 8 fills out the space 5 in a high direction. Thereby, air can only pass between the first subspace 9 and the second subspace 10 via a passage 11 located below the lower end 8b of the elongated element. The first subspace 9 comprises a first opening 12 in connection to the upper frame element 3a and the second subspace 10 comprises a second opening 13 in connection to the upper frame element 3a. The light absorbing device 1 is applied such that the lower edges of the openings 12, 13 are located at substantially the same level. The respective openings 12, 13 are connected with conduits 12a, 13a extending through the wall element 6.

The first subspace comprises an upper portion 9a located between the elongated element 8 and the side frame element 3c. The upper portion 8a of the first subspace defines the beginning of a path leading air through the space 5. In the upper portion 8a of the first subspace, air is conducted substantially straight downwardly from the opening 12. The path has a successively increased cross section area in the flow direction of the air. In order to give the path a successively increased cross section area, the elongated element 8 forms an angle v to a vertical line. The angle v may be within the range of 1° to 45°, preferably within the range of 10° to 30°. Thus, the path provides, in the upper portion 9a of the first subspace, a successively increased width in the flow direction of the air down to a limit line 9c. The limit line 9c marks a transition to a lower portion 9b of the first sub space. The limit line 9c extends perpendicularly from an inner surface of the side frame element 3c to the lower end 8b of the elongated element. The passage 11 between the first subspace 9 and the second subspace 10 extends perpendicularly from an inner surface of the lower frame element 3d to the lower end 8b of the elongated element. The limit line 9c and the passage 11 define together with the frame element 3b, c the lower portion 9b of the first subspace. The path is equally wide or wider at the passage 11 than at the limit line 9c. Thus, the path obtains a constant cross section area or an increased cross section area in the lower portion 9b of the first subspace.

The second subspace 10 can be divided in an upper portion 10a and a lower portion 10b with a limit line 10c. The limit line 10c extends perpendicularly from an inner surface of the side frame element 3d to the lower end 8b of the elongated element. By the inclination of the elongated element 8, the path provides a successively increased width in the upper portion 10a of the second subspace. Advantageously, the outlet opening 13 in the second subspace 10 is larger than the inlet opening 12 into the first subspace 9. The outlet opening 13 may have a cross section area which is 1, 1 to 2, 0 times larger than the cross section area of the inlet opening 12. The second subspace 10 has a volume which is larger than the volume of the first sub spaces 9. The volume of the second subspace 10 may be 2 to 5 times larger than the volume of the first sub spaces 9.

When the sun lights on the light absorbing device 1, the solar radiation passes through the transparent glass plate 2 and lights on the radiation absorbing plate 4 such that it is heated. The radiation absorbing plate 4 heats in its turn the adjacent the air in the space 5. When the air in the space 5 obtains a higher temperature than the air in the inlet conduit 12a the air becomes gradually warmer in the larger second subspace 10 than in the smaller first subspace 9. The thermal unbalance between the subspaces 9, 10 makes that a natural circulation of air is started such that air will be circulated in a path having an extension from the opening 12 into the first subspace 9 to the opening 13 in the second subspace 10. Thereby, air is pressed into the first subspace 9, via the opening 12, and downwardly in the upper part 9a of the first subspace along a path having a successively increased cross section area in the flow direction of the air. When the downwardly flowing air passes the limit line 9c and reaches the lower part 9b of the first subspace, it changes direction and is guided towards the second subspace 10. The air from the first subspace 9 is conducted, via the passage 11, to the second subspace 10. The air obtains in the second space 10 a higher and higher temperature and thus rises upwardly in the second space 10 until it finally is let out through the opening 13. When warm air is let out through the opening 13, new cold air is pressed in via the opening 12. Since the supplied air has a lower temperature than the air in the second subspace 10, a lower temperature is established in the first subspace 9 than in the second subspace 10. This temperature difference results in that a stable natural circulation of the air is obtained when the light absorbing device is subjected to solar radiation. When the solar radiation ceases, the temperature in the space 5 also drops. The difference in temperature between the air in the space 5 and the air in the conduit 12a ceases. This results in that the temperature difference between the air in the first subspace 9 and the second subspace 10 decreases until the natural circulation of air ceases.

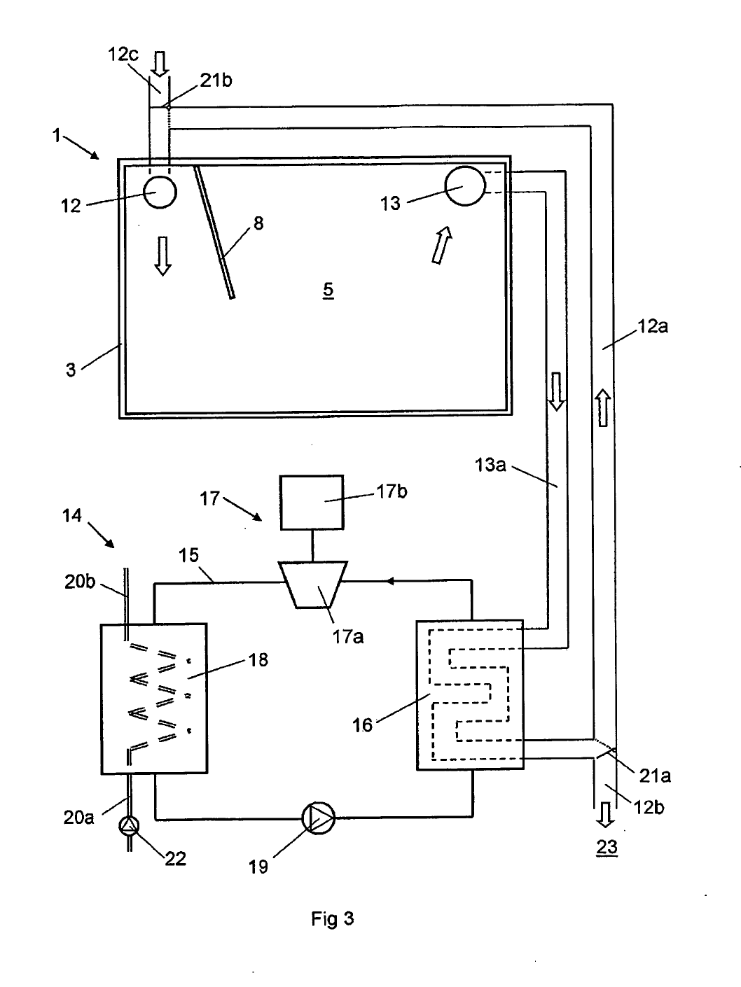

FIG. 3 shows an arrangement comprising a light absorbing device 1 according to the above and an energy transforming device 14. The light absorbing device 1 consists a first unit and the energy transforming device 14 consists a second unit located at a distance from the first unit. The energy transforming device 14 is adapted to absorb heat energy from the warm air in the light absorbing device 1 and to transfer the absorbed heat energy to electric energy. The energy transforming device 14 comprises a circuit 15 with a circulating cooling medium. The circuit comprises an evaporator 16 where the cooling medium is adapted to evaporate and be pressurized by means of the warm air which is conducted to the evaporator 16 via the conduit 13a. The energy transforming device 14 comprises a machine unit 17 adapted to be driven by the evaporated and pressurized cooling medium in the evaporator and to transfer the absorbed heat energy to electric energy. The machine unit 17 comprises a first machine component adapted to transfer the absorbed heat energy to mechanical energy. The first machine component is here exemplified as a turbine 17a but it can certainly be a piston machine or another kind of machine. The machine unit 17 comprises a second machine component adapted to transfer the mechanical energy to electric energy. The second machine component is a generator 17b. The circuit for the cooling medium is closed and it comprises a condenser 18, located downstream of the machine unit 17 with reference the flow direction of the cooling medium in the circuit 15. The cooling medium is adapted to condense in the condenser 18. A pump 19 is arranged in the circuit 15 for conducting the condensed cooling medium from the condenser 18 to the evaporator 16. The cooling medium is a substance which has for this purpose suitable vaporizing and condensation temperatures. Such a cooling medium is for example R 410.

Consequently, the arrangement comprises a conduit 13a leading warm air from the outlet opening 13 of the light absorbing devices 1 to the evaporator 16. Thus, the cooling medium is directly heated in the evaporator 16 by the warm air from the light absorbing device 1. The arrangement comprises a conduit 12a adapted to conduct the air back from the evaporator 16 to the inlet opening 12 of the light absorbing device 1. The arrangement comprises two controllable valves 21a, b which are applied in the conduit 12a. When the valves 21a, b are set in the position shown with solid lines in FIG. 3 the air is conducted from the evaporator 16 back to the inlet opening 12 of the light absorbing device 1. When the valves 21a, b are set in the position shown with broken lines, instead the air is conducted from the evaporator 16 to an outlet conduit 12b. In this case, new air to the light absorbing device 1 is obtained from an inlet conduit 12c. The energy transforming device 14 also comprises a conduct system with a conduit 20a leading a liquid heat carrying medium to the condenser 18. The heat carrying medium has a temperature such that it can cool the cooling medium such that it condensates in the condenser 18. The flow of the heat carrying medium to the condenser 18 is controlled by means of a pump 22. The heat carrying medium may be water or a water solution. The conduit system also comprises a conduit 20b leading away the heat carrying medium after it has passed through the condenser 18.

When the light absorbing device 1 is lighten by the sun, a heating and a natural circulation of air in the space 5 is provided. When the air is let out through the outlet opening 13, it has a markedly increased temperature. The warm air flows through the conduit 13a to the evaporator 16 where it heats the cooling medium. The cooling medium is heated to a temperature at which it is vaporized. The vaporized cooling medium provides an over-pressure in the evaporator. The pressurized cooling medium is conducted to the turbine 17a where it expands. The pressure energy in the cooling medium is transferred to mechanical energy in the turbine 17a. The turbine 17a thus drives the generator 17b which produces electric energy. After the expansion in the turbine 17a, the pressure and the temperature of the cooling mediums are reduced. Thereafter, the cooling medium is cooled in the condenser 18 by the heat carrying medium to a temperature at which it condensates in the condenser 18. The pump 19 conducts the condensed cooling medium back to the evaporator 16.

If there is no need of heating of the building, the valves 21a, b are set in the position shown with the solid lines. Thus, the air is circulated in a closed system between the light absorbing device 1 and the evaporator 16. The heat energy in the air, which not is delivered to the cooling medium in the evaporator 16, is maintained by such a recirculation in the system. The air, which is conducted in the light absorbing device 1 via the inlet opening 12, provides thus an increased temperature. The air, which leaves the light absorbing device 1 via outlet opening 13, provides also an increased temperature. The ability of the air to heat the cooling medium in the evaporator 16 increases and the quantity of cooling medium which is vaporized per time unit increases. The increased production of vaporized cooling medium results in that the turbine 17a and the generator 17b provides a corresponding increased capacity and in that it provides an increased production of electric energy. The liquid heat carrying medium provides a heating in the condenser 18 before it is conducted away via the conduit 20b. The conduit 20b may be connected to a heat storing unit for storing of heat energy which later can be used when there is a need of heating in the building.

If there is a need of heating of the building during operation of the light absorbing device 1, the valves 21a, b are set in the position shown with broken lines. The heat energy, which not can be delivered by the warm air to the cooling medium, is here used in the evaporator 16 for heating purposes. The air leaving the evaporator 16 has a higher temperature than the air in the building. Thus, the air passing through the evaporator 16 can be let out directly, via the outlet conduit 12b, in a space 23 in the building. Air from the building is here conducted, via the inlet conduit 12c, into the light absorbing device 1. In order to provide a further heating, the absorbed heat energy of the heat carrying medium in the condenser 18 is delivered in a radiator or the like for heating the air in the building. Alternatively, a heat pump may be connected to the conduit 20b downstream of the condenser 18 using the heat energy of the heat carrying medium as heat source for heating the air in the building.

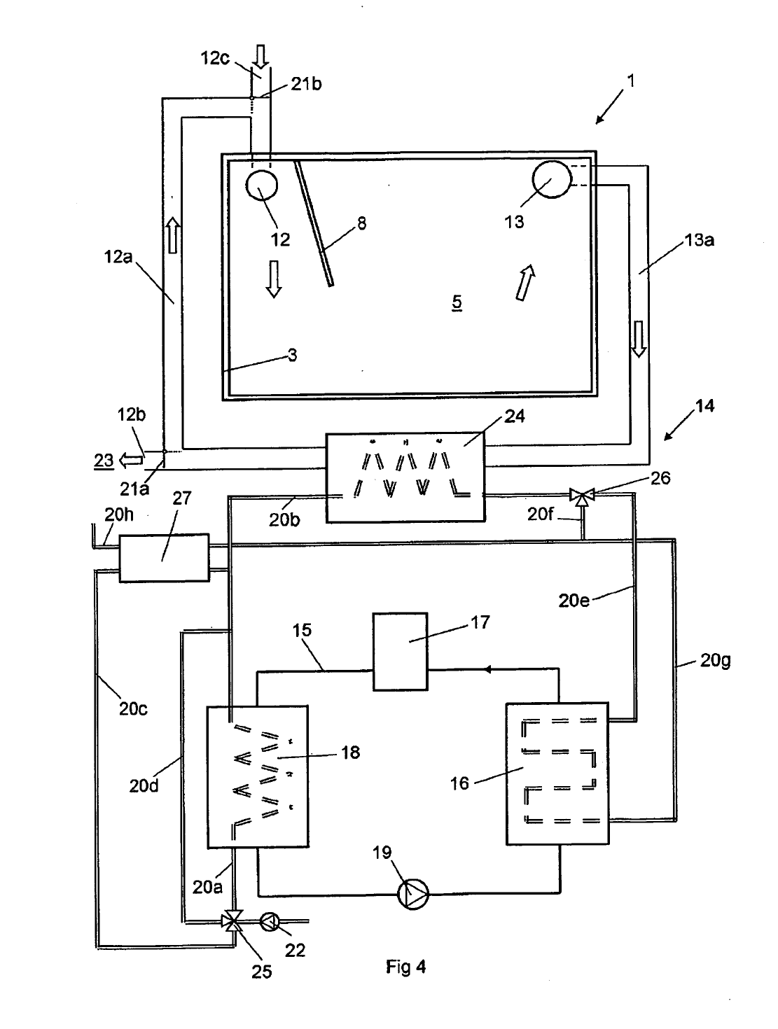

FIG. 4 shows an arrangement comprising a light absorbing device 1 according to the above and an energy transforming device 14 according to a second embodiment. The energy transforming device 14 here comprises a circuit 15 with a circulating cooling medium having a corresponding construction as in the embodiment in FIG. 3. However, in this case, the energy transforming device 14 comprises a heat exchanger 24 where the warm air from the light absorbing device 1 is adapted to deliver heat energy to a liquid heat carrying medium. Thereafter, the heat carrying medium is conducted, via a conduit 20e, to the evaporator 16 where it heats the cooling medium. Consequently, in this case, the warm air from the light absorbing device 1 indirectly heats the cooling medium in the evaporator 16 via the heat carrying medium. The heat carrying medium is the same as is conducted through the condenser 18 for cooling the cooling medium such that it condensates. In this case, valves 25, 26 is used for leading the heat carrying medium in different conduits 20a, c, d, e, f. Furthermore, a heat exchanger 27 is used for absorbing heat energy from the heat carrying medium.

When the light absorbing device 1 is lighten by the sun, a heating and a natural circulation of air in the space 5 is provided. The warm air flows out through the outlet opening 13 and through the conduit 13a to the heat exchanger 24 where the air heats the heat carrying medium. If there is no need of heating of the building, the valves 21a, b are set in the position shown with solid lines. Thus, the air is circulated in a closed system between the light absorbing device 1 and the heat exchanger 24. The heat energy in the air which is delivered to the heat carrying medium in the heat exchanger 24 can thus be maintained in the system. The air, which is conducted in the light absorbing device 1 via inlet opening 12, provides thus an increased temperature. The air, which leaves the light absorbing device 1, via the outlet opening 13, also provides an increased temperature. The ability of the air to heat the heat carrying medium in the heat exchanger 24 increases. The temperature of the heat carrying medium in the conduit 20e can be increased. Thus, an effective heating is provided of the cooling medium in the evaporator 16 and an increased production of electricity by the machine unit 17.

The vale 25 is here set in a position such that the pump 22 conducts the heat carrying medium to the conduits 20a, 20c. The part of the heat carrying medium which is conducted through the conduit 20a provides a heating when it cools the cooling medium in the condenser 18. The part of the heat carrying medium which is conducted through the conduit 20c provides a heating when it is conducted through the heat exchanger 27. Thus, the heat carrying medium obtains in the both conduits 20a, c a heating before they are joined in a common conduit 20b which leads the heat carrying medium to the heat exchanger 24. The heat carrying medium is heated in the heat exchanger 24 by the warm air from the light absorbing device 1. The valve 26 is here set in a position such that the heat carrying medium from the heat exchanger 24 is conducted, via the conduit 20e, to the evaporator 16. After the heat carrying medium has heated the cooling medium in the evaporator 16 it is conducted, via the conduit 20g, to the heat exchanger 27 where it delivers heat to the incoming heat carrying medium in the conduit 20c. When the heat carrying medium is let out, via an outlet conduit 20h, it has only a somewhat higher temperature than when it was pumped into the conduit system by means of the pump 22. Consequently, in this case, the both heat carrying medium and the air obtain small heat losses. A relatively large part of the heat energy which the air obtains in the light absorbing device 1 can thus be used for generating electric energy.

If there is a need of heating of the building during operation of the light absorbing device 1, the valves 21a, b are set in the position shown with broken lines. The heat energy in the air, which is delivered to the cooling medium in the evaporator 16, here can be used for heating purposes. The air, which has a higher temperature when it leaves the evaporator 16 than the air in the building, is here directly conducted, via the outlet conduit 12b, into a space 23 in the building. Internal air from the building is here conducted, via the inlet conduit 12c, into the light absorbing device 1. In this case, the valve 25 is set in a position such that the supplied heat carrying medium is conducted into the conduit 20d. The heat carrying medium is thus conducted past the condenser 18. The heat carrying medium is thereafter conducted through the heat exchanger 24 where it is heated by the warm air from the light absorbing device 1. The valve 26 leads the warm heat carrying medium, via the conduit 20f, to the conduit 20g. Consequently, in this case, the heat carrying medium is not conducted to the evaporator 16. The heat carrying medium is then, via the heat exchanger 27, conducted out via the outlet conduit 20h. Consequently, in this case, no electric energy is produced but only heat energy. The heat carrying medium, which is let out via the outlet conduit 20h, may have a relatively high temperature. The heat carrying medium may be used for producing hot water or for supplying heat to the building via, for example, radiators. By setting the valves 21a, b, 26 in the above mentioned positions, the arrangement can alternatively produce electric energy or heat energy. It is easy to convert the production between electric energy and heat energy.

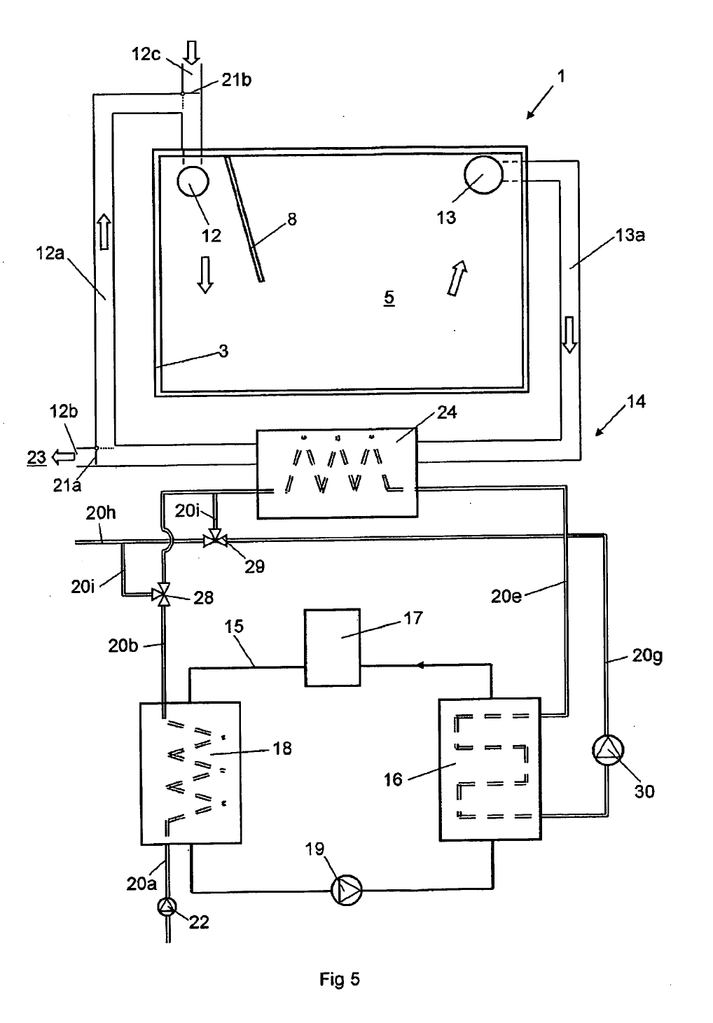

FIG. 5 shows a further embodiment where a heat exchanger 24 is used for transferring heat energy from the air, which has been heated in the light absorbing device 1, to a heat carrying liquid medium. The conduit system for the warm air and the circuit with a circulating cooling medium have a corresponding construction as in the embodiment in FIG. 4. However, the conduit system for the heat carrying medium is somewhat changed. A valve 28 here has been arranged in the conduit system which leads the heat carrying medium, which has been heated in the condenser 18, to the outlet conduit 20h via a conduit 20i or to the heat exchanger 24. Furthermore, a valve 29 here has been arranged in the conduit system which leads the heat carrying medium, which has been cooled in the evaporator 16, to the outlet conduit 20h or back to the heat exchanger 24. A further circulation pump 30 has been arranged in the conduit system.

If the valve 28 is set in a position such that it leads out the heat carrying medium, which has been heated in the condenser 18, to the outlet conduit 20h, the valve 29 is set in a position such that it leads the heat carrying medium, which has been cooled in the evaporator 16, back to the heat exchanger 24. The circulation pump 30 here is used for circulating the heat carrying medium in a substantially closed circuit between the heat exchanger 24 and the evaporator 16. If the valve 28 instead is set in a position such that it leads the heat carrying medium, which has been heated in the condenser 18, to the heat exchanger 24, the valve 29 is set in a position such that it leads the heat carrying medium, which has been cooled in the evaporator 16, to the outlet conduit 20h.

The present invention is not in any way restricted to the embodiments described above in the drawings but may be modified freely within the scope of the claims.

1. An arrangement for generating electric energy, wherein the arrangement comprises a light absorbing device which comprises an outer at least partly transparent material layer, a space through which a gaseous medium is adapted to be circulated and heated by light radiation passing through the outer the material layer, a radiation absorbing material layer located in connection to said space, and an element adapted to divide the space in at least a first subspace comprising a first opening and a second subspace comprising a second opening, wherein the gaseous medium is adapted to flow along a path extending from the opening into the first subspace to the opening in the second subspace and that said path has an extension such that the gaseous medium only has possibility to be conducted from the first subspace to the second subspace via a passage located at a lower level in the space than the levels of the first opening and the second opening, wherein the arrangement comprises an energy transforming device adapted to absorb energy from the gaseous medium which is let out from the second opening of the light absorbing device and to transfer the absorbed heat energy to electric energy.

2. An arrangement according to claim 1, wherein the energy transforming device comprises a circuit with a circulating cooling medium and an evaporator where the cooling medium is adapted to be evaporated and pressurized by means of the absorbed heat energy from the gaseous medium.

3. An arrangement according to claim 2, wherein the energy transforming device comprises a machine unit adapted to be driven by the pressurized cooling medium and to transfer the pressure energy of the cooling medium to mechanical energy.

4. An arrangement according to claim 3, wherein said machine unit comprises a first machine component adapted to transfer the absorbed heat energy to mechanical energy and a second machine component adapted to transfer the mechanical energy to electric energy.

5. An arrangement according to claim 3, wherein said circuit is closed and that it comprises a condenser, located downstream of said machine unit with respect to the flow direction of the cooling medium in the circuit, in which condenser the cooling medium is adapted to condensate before it is again conducted to the evaporator.

6. An arrangement according to claim 5, wherein the energy transforming device comprises a conduit system with a heat carrying medium which is adapted to be conducted through the condenser for cooling the cooling medium such that it condensates in the condenser.

7. An arrangement according to claim 2, wherein the arrangement comprises a heat exchanger where the gaseous medium from the light absorbing device is adapted to deliver heat energy to a heat carrying liquid medium which thereafter is conducted, via a conduit, to the evaporator.

8. An arrangement according to claim 1, wherein the light absorbing device consists a first unit and that the energy transforming device consists a second unit located at a distance from the first unit and that the arrangement comprises a conduit adapted to lead the gaseous medium from the second opening of the light absorbing device to the energy transforming device.

9. An arrangement according to claim 8, wherein it comprises a return conduit adapted to lead the gaseous medium back to the first opening of the light absorbing device after it has delivered heat energy to the energy transforming device.

10. An arrangement according to claim 9, wherein it comprises an outlet conduit adapted to lead out the gaseous medium to a space, where there is a need of heating, after it has delivered heat energy to the energy transforming device.

11. An arrangement according to claim 8, wherein it comprises a valve by which it is possible to control the gaseous medium to the return conduit and/or the outlet conduit after it has delivered heat energy to the energy transforming device.

12. An arrangement according to claim 9, wherein it comprises an inlet conduit for supply of gaseous medium to the first opening and a valve by which it is possible to control the supply of gaseous medium to the first opening from the return conduit and the inlet conduit.

13. An arrangement according to claim 1, characterised in that wherein the second opening has a larger cross section area than the first opening.
